(19) United States
(12) Patent Application Publication
(10) Pub. No.: US 2026/0303622 A1
(43) Pub. Date: Oct. 1, 2026

(54) AUTONOMOUS RULE GENERATION SYSTEM FOR CYBERSECURITY EVENT DETECTION

(71) Applicant: SentinelOne, Inc., Mountain View, CA (US)

(72) Inventors: David Schiff, Givat Shmuel (IL); Gal Abadi, Tel Aviv (IL)

(21) Appl. No.: 19/633,852

(22) Filed: Mar. 30, 2026

Related U.S. Application Data
(60) Provisional application No. 63/781,908, filed on Apr. 1, 2025.

(51) Int. Cl. H04L 9/40; H04L 41/16

(52) U.S. Cl. CPC H04L 63/1416; H04L 41/16

(57) ABSTRACT

Described herein is a system for generating deterministic rules for classification tasks on discrete sequential data. The system generates, by a language model, a candidate rule based on the input data, wherein generating the candidate rule comprises selecting tokens from a smallest set of tokens whose cumulative probability exceeds a threshold, and wherein the candidate rule comprises a deterministic function configured to classify events as malicious or non-malicious. The system evaluates the candidate rule against an evaluation dataset by applying the candidate rule to samples to identify true positive detections and false positive detections, computing performance metrics based on a precision value and a number of true positive detections, and determining whether the performance metrics meet a threshold level. The system generates and provides feedback to the language model when the performance metrics do not meet the threshold level, wherein the feedback comprises at least one true positive sample and at least one false positive sample. The system iteratively refines the candidate rule until the performance metrics meet the threshold level to generate a deterministic rule.

### CROSS-REFERENCE TO RELATED APPLICATIONS

This application claims priority to provisional U.S. Application No. 63/781,908, titled “AUTONOMOUS RULE GENERATION SYSTEM FOR CYBERSECURITY EVENT DETECTION”, filed Apr. 1, 2025, which is hereby incorporated by reference in its entirety. Any and all applications for which a foreign or domestic priority claim is identified in the Application Data Sheet as filed with the present application are hereby incorporated by reference under 37 C.F.R. § 1.57.

### FIELD OF INVENTION

The present disclosure relates to autonomous rule generation systems for cybersecurity.

### BACKGROUND

Cybersecurity threats continue to evolve rapidly, posing challenges for organizations seeking to protect their digital assets and infrastructure. Traditional methods of detecting malicious activities often rely on either machine learning models or manually written detection rules. Machine learning models have shown promise in their ability to generalize and detect novel threats. These models can process large volumes of data and identify patterns indicative of malicious behavior. However, they often require extensive research to identify relevant features, substantial computational resources for training and deployment, and may become less effective as the threat landscape changes.

Manually written detection rules, on the other hand, offer precise control and explainability. Security analysts can craft rules tailored to specific attack techniques, making them easier to understand and modify. However, the process of creating and maintaining these rules is time-consuming and labor-intensive. Additionally, manually written rules may struggle to keep pace with the rapid emergence of new attack vectors. The cybersecurity industry faces an ongoing challenge in balancing the desire for accurate threat detection with the constraints of computational resources and human expertise.

As cyber-attacks become more sophisticated, the ability to quickly generate and refine detection rules becomes increasingly valuable. The field of natural language processing and large language models has made substantial progress in recent years. These advancements present opportunities to explore new approaches in cybersecurity.

### BRIEF DESCRIPTION OF THE DRAWINGS

Detailed descriptions of implementations of the present invention will be described and explained through the use of the accompanying drawings.

FIG. 1 illustrates a table detailing various metrics of existing methods for event detection.

FIG. 2 illustrates a system diagram of an example system for detection rule generation according to some implementations herein.

FIG. 3 is a system diagram illustrating an example of a computing environment in which the disclosed system operates in some implementations of the present technology.

FIG. 4 is a system diagram illustrating an example of a computing environment in which the disclosed system operates in some implementations.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Although several implementations, examples, and illustrations are disclosed below, it will be understood by those of ordinary skill in the art that the inventions described herein extend beyond the specifically disclosed implementations, examples, and illustrations and includes other uses of the inventions and obvious modifications and equivalents thereof. implementations of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific implementations of the inventions. In addition, implementations of the inventions can comprise several novel features and no single feature is solely responsible for its desirable attributes or is essential to practicing the inventions herein described.

### Introduction

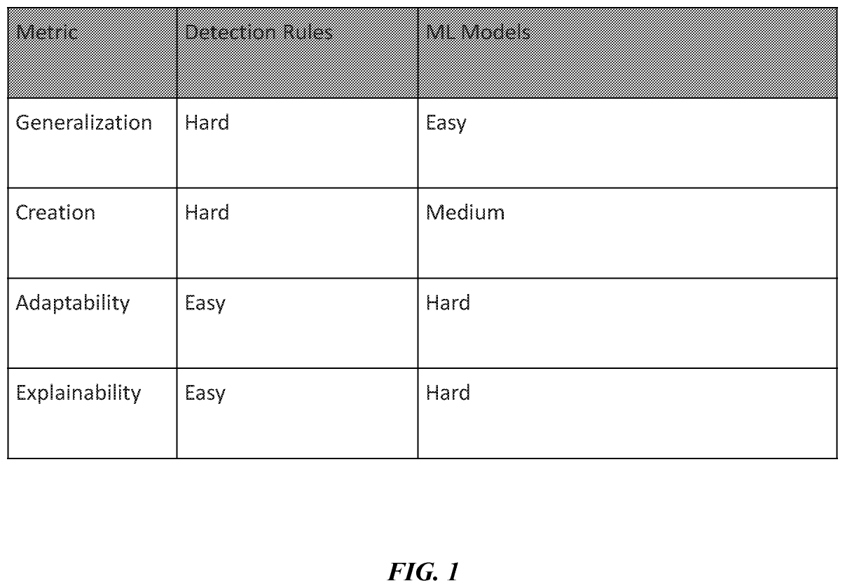

In the field of cybersecurity, the detection of malicious events and activities presents ongoing challenges for organizations seeking to protect digital assets and infrastructure. Some existing approaches to identifying and mitigating cyber threats have relied on two primary methods: machine learning models and manually crafted detection rules. Each of these methods offers distinct advantages while also presenting inherent limitations that may hinder effectiveness in the face of sophisticated and dynamic cyber threats. FIG. 1 illustrates a table detailing various metrics of existing methods for event detection. Machine learning models have demonstrated capability in generalizing and detecting novel threats. These models may process large volumes of data and identify patterns indicative of malicious behavior. However, machine learning models may require extensive research to identify relevant features, substantial computational resources for training and deployment, and may become less effective as the threat landscape changes. Additionally, the explainability of such models may be limited, making it difficult for cybersecurity professionals to understand and validate the logic behind threat detections.

Manually written detection rules, on the other hand, offer precise control and explainability. Security analysts may craft rules tailored to specific attack techniques, making the rules easier to understand and modify. However, the process of creating and maintaining these rules may be time-consuming and labor-intensive. Additionally, manually written rules may struggle to keep pace with the rapid emergence of new attack vectors. While manual detection rules may be lightweight and deployable on client endpoints to detect malicious events without additional memory or compute overhead, these rules may require substantial effort to generate and may rarely generalize to new attack vectors.

The autonomous rule generation system described herein addresses these challenges by combining the strengths of both machine learning and manual rule creation approaches. The system leverages large language models to autonomously generate deterministic rules for detecting malicious events in cybersecurity data, particularly in the context of Extended Detection and Response (XDR) systems. Through utilization of the semantic understanding capabilities of large language models, the system may quickly and efficiently generate deterministic rules that capture patterns of malicious behavior in cybersecurity events. As used herein, a “deterministic rule” refers to a rule, function, expression, query, or other machine-executable logic that, when applied to a given input sample having a defined set of attributes, produces the same classification result for that input sample each time the rule is executed under the same conditions. In some implementations, a deterministic rule operates by evaluating one or more explicit conditions over structured event attributes, such as process identifiers, command-line arguments, file paths, network addresses, protocol fields, timestamps, user identifiers, registry values, cloud resource attributes, or combinations thereof, and producing a binary or categorical output such as malicious, non-malicious, suspicious, or matched/not matched.

The autonomous rule generation system described herein may offer several advantages over existing methods. For example, the system may provide improved generalization by leveraging the broad knowledge encoded in large language models. The system may enable faster rule creation compared to manual approaches by automating the rule generation process. The system may enhance adaptability to emerging threats through iterative refinement based on feedback. The system may maintain explainability of detection logic by generating deterministic rules that may be easily interpreted by human analysts. This explainability may be valuable for cybersecurity professionals who need to understand and validate the logic behind threat detections, as well as for compliance and auditing purposes.

In some implementations, the autonomous rule generation system combines a large language model with a feedback-driven optimization process. In some implementations, the system may rapidly create deterministic rules that capture complex patterns in cybersecurity events while maintaining flexibility to adapt to new threats. In some implementations, the system may iteratively refine and evaluate generated rules to balance precision and coverage of true positive cases. The deterministic nature of the generated rules preserves explainability that may be lacking in complex machine learning models.

In some implementations, the autonomous rule generation system may be particularly valuable in the context of XDR data, where the volume and complexity of events may overwhelm traditional manual analysis approaches. Through automation of the rule generation process, the system may reduce the time and effort required to develop effective detection rules, allowing cybersecurity teams to focus on higher-level strategic tasks and incident response. Additionally, the generated rules may be lightweight and deployable to client endpoints or cloud-based detection infrastructure. This may enable organizations to implement threat detection capabilities without incurring additional computational overhead or memory requirements.

In some implementations, the autonomous rule generation system may also include mechanisms for handling edge cases and adapting to new types of threats. When encountering previously unseen patterns in data, the system may be capable of generating novel rules or modifying existing rules to capture these new patterns effectively. In some implementations, the system may process large volumes of cybersecurity data and generate rules for diverse types of threats through efficient data processing techniques, parallelization of rule generation and evaluation processes, and optimized algorithms for rule refinement.

The field of cybersecurity faces persistent technical challenges in detecting malicious events and activities within digital infrastructure. Organizations seeking to protect digital assets encounter difficulties in developing detection mechanisms that are both effective and practical to deploy and maintain.

As noted above, machine learning models present several technical limitations when applied to cybersecurity threat detection. These models may require substantial computational resources for both training and deployment phases. The training process may involve processing large datasets of labeled security events, which may consume considerable memory and processing capacity. Once deployed, machine learning models may continue to require computational resources to perform inference on incoming security events. Furthermore, as the threat landscape evolves, machine learning models may become less effective over time. Features that the models rely upon for detection may become irrelevant as attackers modify their techniques, requiring periodic retraining or replacement of models. This degradation in effectiveness may occur without clear indication to security operators, leaving organizations vulnerable to threats that the models no longer detect reliably. Machine learning models may also exhibit low explainability, operating as opaque systems where the reasoning behind individual detection decisions may not be readily apparent to human analysts. This lack of transparency may create difficulties for security teams attempting to validate detections, investigate incidents, or explain detection logic for compliance and auditing purposes.

Manually written detection rules present a different set of technical challenges. The process of creating these rules may be time-consuming and labor-intensive, requiring security analysts to study attack techniques, identify distinguishing characteristics, and translate this knowledge into formal rule syntax. This manual process may consume substantial human expertise and effort for each rule created. Additionally, manually written rules may struggle to keep pace with the rapid emergence of new attack vectors. As attackers develop new techniques and modify existing approaches, the rules may require continuous updates to maintain effectiveness. The rate at which new threats emerge may exceed the capacity of security teams to create and update rules manually. While manually written rules may offer precise control and may be lightweight for deployment on client endpoints, the effort required to generate these rules may limit the breadth of coverage that organizations can achieve.

The cybersecurity field faces an ongoing challenge in balancing the need for accurate threat detection with constraints on computational resources and human expertise. Organizations may have limited computational capacity available for security detection systems, particularly on endpoint devices where resource consumption may impact user experience and system performance. Simultaneously, organizations may have limited security analyst capacity to dedicate to rule creation and maintenance activities. This balance between detection accuracy, computational efficiency, and human resource constraints creates demand for approaches that may combine the adaptability of machine learning with the precision and explainability of rule-based systems while mitigating the respective limitations of each approach.

In some implementations, the autonomous rule generation system may provide improved generalization compared to manually written detection rules. Manually written rules may be tailored to specific attack techniques observed at the time of rule creation, which may limit the ability of such rules to detect variations or novel manifestations of similar attack patterns. The autonomous rule generation system leverages the broad knowledge encoded in large language models, which may have been trained on diverse text data spanning multiple domains. This broad knowledge base may enable the language model to identify underlying patterns and relationships in cybersecurity data that may not be immediately apparent to human analysts. The language model may generalize from specific examples of malicious behavior to create rules that capture broader categories of threats, detecting attack variations that were not explicitly present in the training data.

In some implementations, the autonomous rule generation system may enable faster rule creation compared to manual approaches. The process of manually creating detection rules may require security analysts to study attack techniques, identify distinguishing characteristics of malicious behavior, and translate this knowledge into formal rule syntax. This manual process may consume substantial time and human expertise for each rule created. The autonomous rule generation system may automate portions of this process by leveraging the language model to analyze samples of malicious behavior and generate candidate rules. The iterative refinement process may further accelerate rule development by automatically incorporating feedback from evaluation results to improve rule quality. This automation may reduce the time required to develop effective detection rules, potentially allowing organizations to respond more quickly to emerging threats.

In some implementations, the autonomous rule generation system may provide enhanced adaptability to emerging threats. As attackers develop new techniques and modify existing approaches, detection systems may require updates to maintain effectiveness. The autonomous rule generation system may adapt to new threats through an iterative refinement process, which incorporates feedback about rule performance against current data. When new types of malicious behavior are identified and added to the labeled dataset, the system may generate rules to address these new patterns. The system may also modify existing rules or generate novel rules when encountering previously unseen patterns in the data. This adaptability may help organizations maintain detection coverage as the threat landscape evolves.

In some implementations, the autonomous rule generation system may provide explainability of detection logic. Traditional machine learning models used for threat detection often operate as opaque systems where the reasoning behind individual detection decisions may not be readily apparent to human analysts. In contrast, the deterministic rules generated by the autonomous rule generation system may be expressed in a format that is interpretable by human analysts. Security professionals may examine the conditions and logic of generated rules to understand why specific events are flagged as malicious. This explainability may be valuable for incident investigation, where analysts may need to understand the basis for a detection to assess the severity and scope of a potential threat.

In some implementations, the autonomous rule generation system may produce rules that are lightweight and deployable to client endpoints. Machine learning models used for threat detection may require substantial computational resources for inference, including memory to store model parameters and processing capacity to perform calculations. These resource requirements may limit the ability to deploy machine learning models on endpoint devices where computational capacity may be constrained. However, the deterministic rules generated by the autonomous rule generation system may be expressed as functions that evaluate conditions against event data without requiring the computational overhead associated with machine learning inference. This lightweight nature may enable deployment of generated rules to client endpoints, allowing organizations to implement detection capabilities closer to the source of security events.

In some implementations, the autonomous rule generation system may reduce computational overhead compared to complex machine learning models. Machine learning models may require computational resources for both training and deployment phases. Training may involve processing large datasets and performing iterative optimization of model parameters, which may consume considerable processing capacity and time. Deployment may require resources to load model parameters into memory and perform inference calculations for each incoming event. The autonomous rule generation system may reduce computational overhead by generating deterministic rules that may be evaluated with simpler computational operations. While the rule generation process may utilize computational resources during the iterative refinement phase, the resulting rules may be deployed and executed with reduced ongoing computational requirements compared to machine learning inference.

In some implementations, the autonomous rule generation system may enable organizations to implement threat detection capabilities without incurring substantial additional memory requirements. Machine learning models may require memory allocation to store model parameters, which may be substantial for complex models with many parameters. The deterministic rules generated by the autonomous rule generation system may be stored and executed with reduced memory footprint compared to machine learning models. This reduced memory requirement may be particularly valuable for deployment on endpoint devices where memory capacity may be limited and where security detection systems may compete with other applications for available memory resources.

In some implementations, the autonomous rule generation system provides a technical improvement to computer functionality in the field of cybersecurity threat detection. The system addresses specific technical problems that arise in computer-based security monitoring, including the computational burden of processing large volumes of security event data, the difficulty of maintaining effective detection mechanisms as threat patterns evolve, and the resource constraints that limit deployment of detection capabilities on endpoint devices.

In some implementations, the system transforms raw cybersecurity event data into deterministic detection rules through a series of iterative refinement processes. This transformation involves receiving labeled cybersecurity event data as input, where the data includes samples of both malicious and non-malicious events. The language model analyzes the input data and generates candidate rules that express conditions for identifying malicious patterns. The validator applies the candidate rules against the labeled dataset to measure detection performance. The feedback module provides information about rule performance back to the language model, enabling generation of refined rule candidates in subsequent iterations. This iterative process continues until rules meeting predefined performance criteria are generated.

The transformation performed by the system produces a concrete technical output in the form of deterministic rules that may be deployed within computer systems to detect malicious events. These deterministic rules represent a specific technical solution that improves the functioning of computer systems tasked with security monitoring. The rules may be expressed as functions that evaluate conditions against incoming event data, enabling computer systems to classify events as malicious or non-malicious based on the rule logic.

In some implementations, the system improves the technical process of generating detection rules by automating portions of the rule creation workflow. Manual creation of detection rules may require human analysts to examine samples of malicious behavior, identify distinguishing characteristics, and translate this knowledge into formal rule syntax. The system automates this process by leveraging the language model to analyze malicious samples and generate candidate rules, with the evaluation and feedback modules providing automated assessment and refinement guidance. This automation represents a technical improvement to the rule creation process that may reduce the time required to develop effective detection rules.

In some implementations, the iterative refinement process employed by the system provides a technical mechanism for improving rule quality without requiring additional human intervention. When a generated rule does not meet performance criteria, the system automatically provides feedback to the language model and generates refined rule candidates. This automated refinement loop may continue for multiple iterations, with each iteration potentially producing rules with improved detection characteristics. The system may terminate the refinement process after a predefined number of iterations or when a rule meeting the performance criteria is generated, providing a controlled mechanism for balancing rule quality against computational resource consumption.

In some implementations, the system addresses the technical challenge of maintaining detection coverage as the evaluation dataset changes. When a rule is successfully generated and meets performance criteria, the system may remove the corresponding true positive samples from the evaluation set. This removal mechanism ensures that subsequent rule generation iterations focus on samples that are not yet covered by existing rules, enabling the system to progressively expand detection coverage across different patterns of malicious behavior. This technical approach may result in a more comprehensive set of detection rules that collectively address a broader range of threat patterns.

In some implementations, the sampling strategies employed by the system provide technical mechanisms for promoting diversity in generated rules. The token sampling technique selects tokens from a distribution of probable tokens where the cumulative probability is below a predefined threshold, which may prevent the language model from consistently generating identical or highly similar rules. The random sampling of true positive and false positive examples for feedback may expose the language model to varied combinations of data points across iterations, which may contribute to generation of rules that address different aspects of the malicious patterns present in the data.

The following sections will describe the specific components, processes, and methodologies that comprise the autonomous rule generation system according to some implementations herein.

### System Components

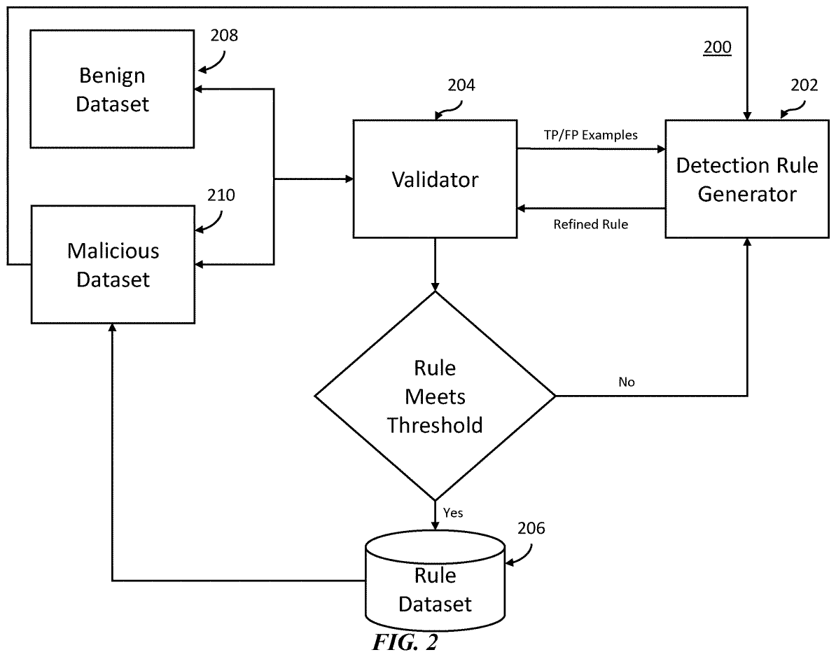

The autonomous rule generation system may comprise several interconnected components to generate effective deterministic rules for classification tasks on discrete sequential data, particularly in the context of cybersecurity event detection. FIG. 2 illustrates a system diagram of an example system for detection rule generation according to some implementations herein. In some implementations, the autonomous rule generation system addresses the technical challenges described above through a combination of interconnected components that work together to generate deterministic rules for classification tasks on discrete sequential data. As used herein, “discrete sequential data” refers to data composed of individual records, tokens, events, log entries, messages, or other separately identifiable units that occur in an order or sequence. In the cybersecurity context, discrete sequential data may include ordered event logs, sequences of process executions, sequences of network connections, authentication event streams, file operation histories, registry modification sequences, API call sequences, cloud activity records, or other temporally or logically ordered security-relevant observations. Each unit within the sequence may include one or more structured attributes, and the order of the units may itself carry information relevant to classification.

In some implementations, at the core of the system 200 is a detection rule generator 202. The detection rule generator 202 may comprise an LLM, which serves as the primary engine for rule generation. In some implementations, the LLM has been trained on vast amounts of text data, enabling it to understand and generate human-like text across a wide range of domains. In the context of cybersecurity rule generation, the LLM may be fine-tuned or prompted with domain-specific information to enhance its performance in generating relevant and effective rules. In some implementations, the detection rule generator 202 may function using a dataset of labeled data, including benign dataset 208 and malicious dataset 210. In some implementations, a sample is taken from malicious dataset 210. The sample is provided to the detection rule generator 202 and the detection rule generator 202 is requested to generalize the sample and create a deterministic rule that would capture similar true positives as the sample while minimizing false positives.

In some implementations, the LLM serves as the core engine for generating candidate rules within the autonomous rule generation system 200. In some implementations, the language model may be a pre-trained model that has been fine-tuned on cybersecurity-specific data to enhance its performance in generating relevant rules. The model may take as input various forms of cybersecurity data, including but not limited to network traffic logs, system event logs, and/or application logs. The LLM may employ several techniques to generate diverse and effective rule candidates. One such technique involves sampling multiple rule candidates for each input scenario. In some implementations, the system may generate n rule candidates, where n may be a predefined parameter or dynamically adjusted based on the complexity of the input data and the desired level of rule diversity.

In some implementations, the system may employ multiple strategies to enhance the diversity and effectiveness of generated rules during the iterative refinement process. For example, the detection rule generator 202 may generate n rule candidates in each iteration, where n is a configurable parameter, increasing the likelihood of discovering novel and effective rule structures. When generating each rule candidate, a token sampling technique may be employed, selecting tokens from a distribution of probable tokens where the cumulative probability of the selected tokens exceeds (or is less than) a predefined threshold p. This approach may promote diversity in the generated rules and lead to more innovative detection patterns. In some implementations, the system 200 may randomly sample true positive and false positive examples from the dataset to provide as feedback to the language model, selecting actual data points or events from the evaluation set. This random sampling may help ground the rule refinement process in concrete, real-world examples and contribute to the overall variability of the system's responses. When providing feedback to the rule detection generator 202, the system may include the randomly sampled true and false positive examples as part of the prompt, enabling the LLM to generate more targeted and relevant refinements to address specific patterns or edge cases in the data. These strategies, combined with other techniques such as iterative refinement with memory, dynamic parameter adjustment, and ensemble rule generation, may enhance the system's ability to generate a wide range of effective and innovative rules for detecting malicious patterns in cybersecurity data.

As noted above, to further enhance the diversity of generated rules, the LLM may utilize a token sampling module. Using sampling, each token in a generated rule may be sampled from a distribution of probable tokens. The system may define a probability threshold p, and only tokens whose cumulative probability is greater than (or in some cases less than) p may be considered for sampling. This technique may help prevent the model from consistently generating the same or highly similar rules, increasing the likelihood of discovering novel and effective detection patterns. The token sampling approach may be implemented using various methods, such as top-k sampling or nucleus sampling. In some implementations, the system may dynamically adjust the sampling parameters based on the performance of previously generated rules or the characteristics of the input data.

To further promote diversity in rule generation, the LLM may incorporate contextual information from the dataset. For instance, the system may randomly sample true positive and false positive examples from the dataset and include these as part of the prompt to the LLM. By providing concrete examples of correct and incorrect detections, the model may be better equipped to generate rules that address specific patterns and edge cases in the data.

In some implementations, the LLM may employ a multi-step generation process. This process may involve first generating an unrefined rule, followed by subsequent refinement steps to expand on the details and specific conditions of the rule. In some implementations, the detection rule generator 202 may also incorporate domain-specific knowledge and/or heuristics to guide the rule generation process. This may include predefined templates or patterns commonly used in cybersecurity rule creation, which the LLM can adapt and expand upon based on the specific input data and detection requirements. In some implementations, the LLM may be capable of generating rules in multiple formats or languages, depending on the specific requirements of the deployment environment. This flexibility may allow the system to produce rules that can be directly integrated into various cybersecurity tools and platforms without the need for manual translation or adaptation.

Working in tandem with the LLM is a validator 204. Validator 204 may be responsible for assessing the quality and effectiveness of the rules generated by the detection rule generator 202. The validator 204 may assess the effectiveness of candidate rules generated by the LLM by applying the generated rules to a dataset of labeled cybersecurity events, measuring their performance in terms of precision, recall, and/or other relevant metrics. This evaluation process may be critical in determining which rules are sufficiently effective to be included in a final rule dataset 206. The deterministic rule may be written as a function and may be evaluated on the entire dataset, including benign dataset 208 and malicious dataset 210. The evaluation of rules may be measured in various metrics. In some implementations, a fitness function may be used to evaluate and select the best rule generated by the language model. This fitness function may incorporate multiple criteria to assess the quality and effectiveness of each candidate rule. The primary metrics considered in the fitness function may include precision and the number of true positives detected by the rule. In some implementations, the precision metric may measure the proportion of correctly identified malicious events among all events flagged as malicious by the rule. A high precision score may indicate that the rule is effective at minimizing false positives, which is important in cybersecurity contexts where false alarms can lead to unnecessary resource allocation and potential alert fatigue. The number of true positives may reflect the rule's ability to capture a significant portion of the actual malicious events present in the dataset. A higher number of true positives may indicate that the rule has good coverage and may be effective at identifying various manifestations of malicious behavior. In some implementations, the fitness function may combine these metrics into a single score, using a weighted sum or other mathematical formulation. The weights assigned to each metric may be adjustable, allowing the system to prioritize precision or coverage based on specific use cases or organizational requirements. In some implementations, the rule selection process may incorporate additional criteria beyond the fitness function score. For example, the system may consider the diversity of the selected rules, ensuring that the final ruleset covers a wide range of potential threat patterns.

In addition to precision and true positive count, the validator 204 may consider other relevant metrics depending on the specific requirements of the cybersecurity application. These metrics may include, for example, recall (the proportion of actual malicious events correctly identified), F1 score (the harmonic mean of precision and recall), or area under the receiver operating characteristic curve (AUC-ROC).

In some implementations, the validator 204 may apply each candidate rule to a designated evaluation dataset, which may be a subset of the overall labeled dataset, or a separate holdout set. This approach may help ensure that the rules generalize well to unseen data and are not overfitted to the training examples. In some implementations, the validator 204 may also employ cross-validation techniques to obtain a more robust assessment of rule performance. Cross-validation may involve partitioning the dataset into multiple subsets and evaluating each rule across different combinations of these subsets, providing a more comprehensive view of the rule's effectiveness across various data distributions. In some implementations, the validator 204 may also incorporate mechanisms for handling class imbalance, which may be common in cybersecurity datasets where malicious events are typically rarer than benign ones. These mechanisms may include, for example, techniques such as stratified sampling or adjusting evaluation metrics to account for class distribution. In some implementations, the validator 204 may also incorporate mechanisms for detecting potential overfitting or rule brittleness, including evaluating rules on multiple datasets with varying characteristics or artificially perturbing the evaluation data to assess rule robustness.

In some implementations, the validator 204 may provide detailed performance breakdowns for each rule, including information about specific true positives, false positives, and false negatives. This granular feedback may be valuable for the feedback module and/or detection rule generator 202 in guiding further refinements to the rule generation process.

To handle cases where the language model struggles to generate an effective rule from a given sample, the system may implement a refinement loop. This loop may allow for multiple iterations of rule generation and improvement, up to a predefined limit m, or another heuristic which indicates the rule cannot be further refined. If the number of iterations reaches m without producing a satisfactory rule, the system may opt to sample a new true positive example and restart the generation process.

To implement the feedback loop, a feedback module, or the validator 204 itself, may analyze the evaluation results from the validator 204 and generate appropriate feedback for the detection rule generator 202. In some implementations, the feedback may include information about false positives, false negatives, and/or other performance metrics. This feedback loop refines and improves the generated rules over multiple iterations. For example, if a rule generated by the detection rule generator 202 is validated with a higher score than a predetermined score S, the rule may be stored in rule dataset 206. However, if a rule was generated but the evaluation was deemed poor (e.g., lower than S) the rule and feedback may be returned to the detection rule generator, 202, which may be prompted to generate another rule with the feedback from the evaluation. As such, the system 200 may operate in an iterative manner, with the detection rule generator 202 generating initial rule candidates, the validator 204 assessing rule performance, and the feedback module providing insights for improvement. This cycle may continue until rules meeting the predefined performance threshold are generated or a maximum number of iterations is reached.

The system may terminate refinement of a particular sample after a predefined number of iterations. In some implementations, the system may dynamically adjust the number of allowed iterations based on factors such as complexity of the input data, overall performance of generated rules, and time constraints imposed by operational requirements.

In some implementations, the system may remove true positive samples covered by accepted rules from the evaluation set. When a rule is successfully generated and meets predefined performance criteria, the system may clear corresponding true positive samples from the evaluation set. This clearing process may help prevent redundancy in rule generation and may ensure that subsequent iterations focus on uncovered patterns or events. The system may continue iterating on remaining samples in the evaluation set after clearing successfully generated rules, allowing the system to progressively address different aspects of the threat landscape and potentially leading to a more comprehensive set of detection rules.

As described above, in some implementations, the autonomous rule generation system comprises several interconnected components that integrate to generate deterministic rules for classification tasks on discrete sequential data. These components include a, for example, detection rule generator, a sampling module, a validator, a feedback module, and a rule dataset.

The detection rule generator serves as the primary engine for generating candidate rules within the autonomous rule generation system. The detection rule generator may comprise a language model that has been trained on text data, enabling the language model to understand and generate text across a range of domains. In the context of cybersecurity rule generation, the language model may be fine-tuned or prompted with domain-specific information to enhance performance in generating relevant and effective rules. The detection rule generator may receive samples from a dataset of labeled data and may be requested to generalize the samples and create deterministic rules that would capture similar true positives while minimizing false positives. The detection rule generator may generate multiple rule candidates for each input scenario, where the number of candidates may be a predefined parameter or may be dynamically adjusted based on the complexity of the input data and the desired level of rule diversity.

The sampling module implements various sampling strategies to select appropriate data points for rule creation and evaluation. The sampling module may employ a token sampling technique when generating rule candidates, where tokens for the rule candidates may be sampled from a distribution of probable tokens where the cumulative probability of the selected tokens is below a predefined threshold. This token sampling approach may promote diversity in the generated rules by preventing the detection rule generator from consistently generating identical or highly similar rules. The sampling module may also randomly sample true positive and false positive examples from the dataset to provide as feedback to the detection rule generator. This random sampling may help ground the rule refinement process in concrete examples from the data and may contribute to variability in the system responses across iterations.

The validator assesses the effectiveness of candidate rules generated by the detection rule generator. The validator may apply generated rules to a dataset of labeled cybersecurity events and may measure performance in terms of precision, number of true positives, and other relevant metrics. The validator may use a fitness function to evaluate and select between multiple candidate rules, where the fitness function may incorporate multiple criteria to assess the quality and effectiveness of each candidate rule. The validator may apply each candidate rule to a designated evaluation dataset, which may be a subset of the overall labeled dataset or a separate holdout set. The validator may provide detailed performance breakdowns for each rule, including information about specific true positives, false positives, and false negatives.

The feedback module provides feedback to the detection rule generator based on evaluation results from the validator. The feedback module may analyze evaluation results and generate appropriate feedback for the detection rule generator. The feedback may include information about false positives, false negatives, and other performance metrics. The feedback module may provide examples of true positives and false positives from the dataset as part of the feedback, enabling the detection rule generator to generate more targeted and relevant refinements to address specific patterns or edge cases in the data. The feedback module may structure output in a format that is interpretable by the detection rule generator, which may include providing context about why certain examples were classified as true positives or false positives.

The rule dataset stores rules that have been generated and validated by the system. When a rule generated by the detection rule generator is validated with a score higher than a predetermined threshold, the rule may be stored in the rule dataset. The rule dataset may accumulate rules over the course of the rule generation process, with each stored rule representing a deterministic detection mechanism that may be deployed for cybersecurity event classification.

The components of the autonomous rule generation system are interconnected to enable the iterative rule generation and refinement process. The detection rule generator generates initial rule candidates based on input data from the labeled dataset. The sampling module provides data points to the detection rule generator and selects examples for feedback generation. The validator receives candidate rules from the detection rule generator and assesses rule performance against the labeled dataset. The feedback module receives evaluation results from the validator and provides feedback to the detection rule generator to guide subsequent rule generation iterations. This cycle may continue until rules meeting predefined criteria are generated or a maximum number of iterations is reached.

The interconnection between components enables the system to iteratively refine candidate rules using feedback from evaluation results. When a generated rule does not meet performance criteria, the feedback module provides information about rule performance to the detection rule generator, which may then generate refined rule candidates in subsequent iterations. This feedback loop allows the system to progressively improve rule quality without requiring additional human intervention. The system may terminate refinement of a particular sample after a predefined number of iterations, which may prevent the system from becoming stuck on challenging samples and may ensure efficient use of computational resources.

The interconnection between components also enables the system to manage the evaluation dataset as rules are generated. When a rule is successfully generated and meets predefined performance criteria, the system may remove true positive samples covered by the accepted rule from the evaluation set. This removal mechanism enables the system to progressively expand detection coverage across different patterns of malicious behavior.

### Implementation Details

In some implementations, the detection rule generator comprises a language model that serves as the primary engine for rule generation within the autonomous rule generation system. The language model may be a pre-trained model that has been fine-tuned on cybersecurity-specific data to enhance performance in generating relevant rules. Pre-training may involve exposing the language model to large volumes of text data spanning multiple domains, which enables the language model to develop broad understanding of language patterns and relationships. Fine-tuning on cybersecurity-specific data may further specialize the language model for the task of generating detection rules by exposing the language model to terminology, patterns, and structures commonly encountered in cybersecurity contexts. The fine-tuning process may involve training the language model on datasets that include examples of cybersecurity events, detection rules, threat descriptions, and other domain-relevant text.

The language model may take as input various forms of cybersecurity data. The input data may comprise network traffic logs, which may include records of network communications such as source and destination addresses, ports, protocols, packet sizes, and timing information. The input data may also comprise system event logs, which may include records of activities occurring on computer systems such as process executions, file system operations, registry modifications, and user authentication events. The input data may also comprise application logs, which may include records generated by software applications documenting application-specific activities, errors, and state changes. The language model may analyze these various forms of input data to identify patterns and characteristics that may be indicative of malicious behavior.

In some implementations, the language model may employ a multi-step generation process when creating candidate rules. The multi-step generation process may involve first generating an unrefined rule that captures a general pattern or condition for detecting malicious behavior. The unrefined rule may represent an initial approximation of the detection logic without fully specified details or conditions. Following generation of the unrefined rule, the language model may perform subsequent refinement steps to flesh out the details and specific conditions of the rule. These refinement steps may involve adding additional conditions, specifying parameter values, adjusting logical operators, or otherwise modifying the rule structure to improve detection accuracy. The multi-step generation process may allow the language model to approach rule creation in a structured manner, first establishing a general framework and then progressively adding specificity.

The detection rule generator may incorporate domain-specific knowledge and heuristics to guide the rule generation process. The domain-specific knowledge may include predefined templates or patterns commonly used in cybersecurity rule creation. These templates may represent rule structures that have been found effective for detecting particular categories of threats or that conform to conventions used in cybersecurity detection systems. The language model may adapt and expand upon these predefined templates based on the specific input data and detection requirements. The heuristics may include guidelines or principles that inform rule construction, such as patterns of attributes that are commonly associated with malicious behavior or combinations of conditions that have proven effective in distinguishing malicious events from benign events. Incorporation of domain-specific knowledge and heuristics may help guide the language model toward generating rules that are consistent with established practices in cybersecurity detection.

The language model may be capable of generating rules in multiple formats or languages depending on the specific requirements of the deployment environment. Different cybersecurity tools and platforms may use different rule syntaxes or languages for expressing detection logic.

The language model may be configured to adjust temperature settings, which may influence the creativity or conservatism of the outputs generated by the language model. Temperature is a parameter that may control the randomness of token selection during text generation. Higher temperature values may lead to more diverse and varied rule candidates by increasing the probability of selecting less likely tokens during generation. Lower temperature values may result in more focused and predictable outputs by concentrating probability mass on the most likely tokens. Adjusting temperature settings may allow the system to balance between exploration of novel rule structures and exploitation of known effective patterns. In some cases, higher temperature settings may be used during early iterations to encourage generation of diverse rule candidates, while lower temperature settings may be used during later iterations to refine and stabilize high-performing rules.

The sampling module implements various sampling strategies to select appropriate data points for rule creation and evaluation. The sampling module may generate n rule candidates for each input scenario, where n may be a predefined parameter or may be dynamically adjusted based on the complexity of the input data and the desired level of rule diversity. When the input data exhibits higher complexity, such as when malicious events contain numerous attributes or when the patterns distinguishing malicious events from benign events are subtle, the sampling module may increase the number of rule candidates generated to explore a broader range of potential detection approaches. Conversely, when the input data exhibits lower complexity or when the distinguishing patterns are more apparent, the sampling module may generate fewer rule candidates to conserve computational resources. The desired level of rule diversity may also influence the number of candidates generated, with higher diversity requirements leading to generation of more candidates to increase the likelihood of discovering varied rule structures.

The token sampling approach employed by the sampling module may be implemented using various methods. One such method is top-k sampling, where the sampling module restricts token selection to the k most probable tokens at each generation step. The parameter k may define the size of the candidate token set from which the next token is sampled. By limiting selection to the top k tokens, this method may prevent selection of highly improbable tokens while still allowing for variation in the generated output. Another method is nucleus sampling, also referred to as top-p sampling, where the sampling module selects tokens from the smallest set of tokens whose cumulative probability exceeds a threshold p. This method may dynamically adjust the size of the candidate token set based on the probability distribution at each generation step, allowing for more tokens to be considered when the distribution is relatively flat and fewer tokens when the distribution is concentrated on a small number of likely options. Both top-k sampling and nucleus sampling may promote diversity in the generated rules by introducing controlled randomness into the token selection process.

The sampling module may dynamically adjust the sampling parameters based on the performance of previously generated rules or the characteristics of the input data. When previously generated rules have exhibited high performance in terms of precision and true positive detection, the sampling module may adjust sampling parameters to generate rule candidates that are similar to the high-performing rules, potentially by reducing the randomness introduced during token selection. When previously generated rules have exhibited lower performance, the sampling module may adjust sampling parameters to encourage exploration of different rule structures, potentially by increasing the randomness introduced during token selection. The characteristics of the input data may also inform parameter adjustment, with the sampling module potentially using different parameter settings for different categories of cybersecurity events or different types of malicious behavior patterns.

The feedback module may modify the token sampling approach used by the language model to explore different probability thresholds or sampling methods. When the iterative refinement process indicates that generated rules are converging on similar structures without meeting performance criteria, the feedback module may signal the sampling module to adjust the probability threshold used in nucleus sampling or to modify the k parameter used in top-k sampling. This modification may encourage the language model to explore alternative rule structures that may not have been considered under the previous sampling configuration. The feedback module may also signal the sampling module to switch between different sampling methods during the rule generation process, such as transitioning from top-k sampling to nucleus sampling or vice versa, based on the characteristics of the rules generated in previous iterations. This adaptive modification of the token sampling approach may enable the system to balance between exploitation of known effective rule patterns and exploration of novel rule structures throughout the iterative refinement process.

The validator assesses the quality and effectiveness of rules generated by the detection rule generator. When a candidate rule is generated, the validator may evaluate the rule against the labeled dataset to determine how effectively the rule distinguishes malicious events from non-malicious events. The deterministic rule may be written as a function that expresses conditions for classifying events. This function may be evaluated on the entire dataset, including both the benign dataset containing non-malicious samples and the malicious dataset containing samples of malicious behavior. By evaluating the rule function against both categories of samples, the validator may determine how the rule performs in terms of correctly identifying malicious events while avoiding incorrect classification of benign events.

The validator may consider multiple metrics when assessing rule performance. In addition to precision and true positive count, the validator may consider recall, which measures the proportion of actual malicious events that are correctly identified by the rule. A rule with high recall may capture a larger portion of the malicious events present in the dataset, while a rule with low recall may miss a substantial number of malicious events. The validator may also consider F1 score, which represents the harmonic mean of precision and recall. The F1 score may provide a balanced measure of rule performance that accounts for both the accuracy of positive predictions and the coverage of actual positive cases. The validator may further consider area under the receiver operating characteristic curve, which may provide a measure of rule performance across different classification thresholds. These additional metrics may enable the validator to assess rule quality from multiple perspectives and may inform the selection of rules that balance different performance characteristics.

The validator may apply each candidate rule to a designated evaluation dataset. The designated evaluation dataset may be a subset of the overall labeled dataset that has been set aside for evaluation purposes. Alternatively, the designated evaluation dataset may be a separate holdout set that was not used during the rule generation process. Using a separate holdout set may help ensure that the evaluation reflects how the rule would perform on data that was not involved in rule creation, which may provide a more accurate indication of how the rule would perform when deployed against new, previously unseen events. The separation between data used for rule generation and data used for evaluation may help identify rules that generalize well to new data rather than rules that are overly tailored to specific examples encountered during generation.

The validator may employ cross-validation techniques to obtain a more robust assessment of rule performance. For example, cross-validation may involve partitioning the dataset into multiple subsets and evaluating each rule across different combinations of these subsets. In one approach, the dataset may be divided into k subsets, and the rule may be evaluated k times, with each evaluation using a different subset as the evaluation set while the remaining subsets serve other purposes. The results from the k evaluations may be aggregated to produce an overall performance assessment. This cross-validation approach may provide a more comprehensive view of rule effectiveness across various data distributions and may reduce the influence of any particular subset on the overall performance assessment. Cross-validation may help identify rules that perform consistently across different portions of the data rather than rules that perform well on one particular subset but poorly on others.

In some implementations, the validator may incorporate mechanisms for handling class imbalance. In cybersecurity datasets, malicious events may be rarer than benign events, which may create an imbalanced class distribution. This class imbalance may affect evaluation metrics and may make it difficult to assess rule performance accurately. The validator may employ stratified sampling to address class imbalance, where samples are selected in a manner that preserves the relative proportions of different classes in the evaluation set. Stratified sampling may ensure that both malicious and benign events are represented in the evaluation in proportions that reflect the overall dataset composition. The validator may also adjust evaluation metrics to account for class distribution, which may involve weighting metrics based on class frequencies or using metrics that are less sensitive to class imbalance. These mechanisms for handling class imbalance may enable the validator to provide accurate assessments of rule performance even when the dataset contains substantially more benign events than malicious events.

The validator may incorporate mechanisms for detecting potential overfitting or rule brittleness. Overfitting may occur when a rule is overly tailored to specific characteristics of the data used during rule generation, resulting in a rule that performs well on that data but poorly on new data. Rule brittleness may refer to a condition where a rule is sensitive to small variations in the data and may fail to detect malicious events that differ slightly from the examples encountered during generation. The validator may detect potential overfitting by evaluating rules on multiple datasets with varying characteristics. If a rule performs well on one dataset but poorly on another dataset with different characteristics, this discrepancy may indicate that the rule is overfitted to the first dataset. The validator may also detect potential overfitting or brittleness by artificially perturbing the evaluation data and assessing whether the rule maintains its performance. Perturbations may include modifying attribute values, adding noise to the data, or introducing variations that simulate the types of differences that may be encountered in real-world deployment. Rules that maintain performance under perturbation may be more robust than rules whose performance degrades substantially when the data is modified.

The validator may provide detailed performance breakdowns for each rule. The detailed performance breakdowns may include information about specific true positives, which are malicious events that the rule correctly identifies as malicious. The breakdowns may also include information about specific false positives, which are benign events that the rule incorrectly identifies as malicious. Additionally, the breakdowns may include information about specific false negatives, which are malicious events that the rule fails to identify as malicious. By providing information about specific instances in each category, the validator may enable analysis of the types of events that the rule handles correctly and the types of events where the rule makes errors. This granular feedback may be valuable for the feedback module in guiding further refinements to the rule generation process, as the specific examples of errors may indicate patterns or characteristics that the rule should be modified to address.

The feedback module provides feedback to the language model based on evaluation results from the validator. The feedback module may augment the input provided to the language model with additional examples of true positives and false positives. When generating feedback for the language model, the feedback module may select examples from the evaluation dataset that illustrate the performance characteristics of the candidate rule. True positive examples may demonstrate instances where the rule correctly identified malicious events, providing the language model with concrete illustrations of the patterns that the rule successfully captures. False positive examples may demonstrate instances where the rule incorrectly flagged benign events as malicious, providing the language model with specific cases where the rule conditions are overly broad or where the rule fails to distinguish between malicious and benign behavior. By augmenting the input with these additional examples, the feedback module may enable the language model to generate refined rule candidates that address the specific patterns observed in the evaluation results.

The feedback module may employ natural language processing techniques to generate human-readable explanations of rule performance. These natural language processing techniques may analyze the evaluation results and produce textual descriptions that characterize how the rule performed against the dataset. The human-readable explanations may describe the types of malicious events that the rule successfully detected, the types of benign events that the rule incorrectly flagged, and the characteristics that distinguish correctly classified events from incorrectly classified events. The explanations may reference specific attributes or patterns within the cybersecurity events that influenced the classification outcomes. By generating human-readable explanations, the feedback module may provide the language model with contextual information, enabling the language model to understand the qualitative aspects of rule performance and to generate refinements that address identified weaknesses.

The feedback module may adapt its feedback generation strategy based on the progress of the rule generation process. In early iterations of the rule generation process, the feedback module may provide more general feedback to encourage exploration of diverse rule structures. General feedback may include broad characterizations of rule performance, high-level descriptions of the types of events that the rule handles correctly or incorrectly, and suggestions for alternative approaches to detection. This general feedback may encourage the language model to explore varied rule structures and to consider different approaches to capturing malicious patterns. As the rule generation process progresses and candidate rules begin to exhibit improved performance, the feedback module may provide more focused feedback that targets specific aspects of high-performing rules. Focused feedback may include detailed analysis of particular conditions within the rule, specific examples of edge cases where the rule performance could be improved, and targeted suggestions for fine-tuning rule parameters. This adaptation of feedback generation strategy may enable the system to balance between broad exploration during early iterations and targeted refinement during later iterations.

The feedback module may aggregate feedback across multiple iterations or rule generations to identify persistent challenges or patterns. During the iterative refinement process, the feedback module may accumulate information about the performance of candidate rules generated across successive iterations. This accumulated information may reveal patterns in the types of errors that candidate rules consistently make or the types of malicious events that candidate rules consistently fail to detect. The feedback module may analyze the aggregated feedback to identify persistent challenges that the language model has not successfully addressed through individual iteration refinements. When persistent challenges are identified, the feedback module may generate feedback that specifically highlights these recurring issues and may provide additional context or examples to help the language model address the underlying patterns. Aggregation of feedback across multiple iterations may enable the system to identify and address systematic weaknesses in the rule generation process that may not be apparent from analysis of individual iterations in isolation.

The autonomous rule generation system incorporates an iterative refinement process to enhance the quality and effectiveness of generated rules. This iterative refinement process may be particularly valuable when the language model encounters difficulties in generating a satisfactory rule from a given sample of cybersecurity data. When the language model is unable to produce a rule that meets predefined performance criteria, the system may initiate a refinement loop that allows for multiple iterations of rule generation and improvement.

The system may implement rule transformation algorithms that modify existing rule candidates in structured ways. These rule transformation algorithms may generalize certain conditions within a rule candidate, which may involve broadening the scope of conditions to capture a wider range of events that share common characteristics with the malicious samples. Generalization may include replacing specific attribute values with ranges or patterns, removing conditions that are overly restrictive, or abstracting conditions to higher-level categories. The rule transformation algorithms may also specialize certain conditions within a rule candidate, which may involve narrowing the scope of conditions to reduce false positives by targeting more specific characteristics of malicious behavior. Specialization may include adding additional conditions that further constrain the events matched by the rule, replacing general patterns with more specific attribute values, or introducing conjunctive conditions that require multiple characteristics to be present simultaneously. The structured modification of rule candidates through generalization and specialization may enable the system to explore variations of promising rule structures without requiring the language model to generate entirely new rules from scratch.

In some implementations, the system may combine multiple rule candidates generated during the refinement process to create composite rules that capture a broader range of malicious patterns. Composite rules may incorporate conditions or logic from multiple individual rule candidates, combining the strengths of different approaches to detection. The combination process may involve creating disjunctive rules that match events satisfying any of the conditions from the constituent rule candidates, which may increase coverage of malicious events at the potential cost of reduced precision. The combination process may alternatively involve creating conjunctive rules that require events to satisfy conditions from multiple constituent rule candidates, which may increase precision at the potential cost of reduced coverage. The system may also create hierarchical composite rules that apply different constituent rules based on characteristics of the incoming events, routing events to appropriate detection logic based on event attributes or categories. The creation of composite rules may enable the system to leverage the diversity of rule candidates generated across multiple iterations to produce detection mechanisms that address a broader range of threat patterns than any individual rule candidate.

The number of refinement iterations may be controlled by a patience parameter that defines the maximum number of attempts the system will make to refine a rule before moving on to a new sample. The system may dynamically adjust the patience parameter based on factors such as the complexity of the input data, the overall performance of generated rules, and time constraints imposed by operational requirements. When the input data exhibits higher complexity, the system may increase the patience parameter to allow for additional refinement iterations, recognizing that more complex patterns may require more iterations to capture effectively. When the overall performance of generated rules across the rule generation process has been high, the system may reduce the patience parameter for subsequent samples, as the high performance may indicate that the language model is effectively capturing the relevant patterns with fewer iterations. When time constraints are imposed by operational requirements, the system may reduce the patience parameter to ensure that the rule generation process completes within the available time window. This dynamic adjustment of the patience parameter may enable the system to balance between thorough exploration of potential rule improvements and efficient use of computational resources based on the characteristics of the current rule generation task.

In some implementations, the system may define a maximum number of iterations, which may be referred to as, for example, max_iter, as an upper limit on the number of rule generation attempts the system will perform before terminating the process. The max_iter value may serve as a global constraint on the overall rule generation process, distinct from the patience parameter that controls iterations for individual samples. The max_iter parameter may be set based on factors such as computational resources available for the rule generation process, time constraints imposed by operational schedules, and the desired balance between exploration and exploitation in rule generation. When the total number of rule generation attempts reaches the max_iter value, the system may terminate the rule generation process regardless of whether all samples in the evaluation set have been addressed. This termination mechanism ensures that the rule generation process completes within predictable resource and time bounds, which may be valuable for integration of the autonomous rule generation system into operational workflows with defined schedules and resource allocations.

The autonomous rule generation system incorporates dataset management techniques to maintain the quality and relevance of data used throughout the rule generation process. These dataset management techniques may, for example, address challenges that arise as cybersecurity threat patterns evolve over time and as the characteristics of the data used for rule generation and evaluation change. In some implementations, the system may periodically refresh the evaluation set with new samples or emerging threat patterns. As new types of malicious behavior are identified in the cybersecurity landscape, samples representing these new threat patterns may be added to the evaluation set. This periodic refresh may enable the system to remain adaptive to evolving cybersecurity threats by ensuring that the rule generation process considers current threat patterns rather than relying solely on historical data. The refresh process may involve incorporating samples from newly observed attack campaigns, samples representing variations of known attack techniques, or samples that reflect changes in attacker tactics, techniques, and procedures. By maintaining an evaluation set that reflects the current threat landscape, the system may generate rules that are relevant to the types of malicious behavior that organizations are likely to encounter in their operational environments.

In some implementations, the data quality control measures may also include removal of duplicate or near-duplicate samples from the dataset. Duplicate samples may arise when the same event is recorded multiple times or when data from multiple sources is combined without deduplication. Near-duplicate samples may represent events that are substantially similar but differ in minor attributes such as timestamps or identifiers. The presence of duplicate or near-duplicate samples in the dataset may skew evaluation metrics and may cause the rule generation process to overweight certain patterns that are overrepresented due to duplication. The system may identify and remove duplicate samples through exact matching of attribute values and may identify near-duplicate samples through similarity measures that compare samples based on their attribute patterns. Removal of duplicate and near-duplicate samples may result in a dataset that more accurately represents the diversity of events encountered in operational environments.

In some implementations, the data quality control measures may further include validation of label accuracy. Labels in the dataset indicate whether each sample represents malicious or non-malicious behavior, and the accuracy of these labels may directly affect the quality of generated rules. Mislabeled samples may cause the rule generation process to learn incorrect patterns, potentially resulting in rules that fail to detect actual malicious events or that incorrectly flag benign events as malicious. The system may validate label accuracy through automated analysis that identifies samples whose characteristics are inconsistent with their assigned labels. Samples identified as potentially mislabeled may be flagged for manual review by security analysts who may confirm or correct the labels based on expert analysis.

In some implementations, the system may incorporate configurable parameters related to dataset management. These parameters may include the frequency of evaluation set updates, which may determine how often the evaluation set is refreshed with new samples or emerging threat patterns. A higher update frequency may enable the system to respond more quickly to changes in the threat landscape, while a lower update frequency may reduce the computational overhead associated with dataset management operations. The parameters may also include the proportion of samples used for random feedback generation, which may determine what fraction of the evaluation set is sampled when providing feedback to the language model during the iterative refinement process. A higher proportion may provide the language model with more diverse examples during feedback generation, while a lower proportion may reduce the computational cost of feedback generation operations. These configurable parameters may enable organizations to adjust the dataset management behavior of the system based on their specific operational requirements, available computational resources, and the rate at which the threat landscape in their environment evolves.

In some implementations, the autonomous rule generation system incorporates various configuration options and parameters that may be adjusted to optimize performance for different cybersecurity use cases and operational requirements. These configuration options may also enable organizations to tailor the behavior of the system based on available computational resources, detection priorities, and the characteristics of the threat landscape in their specific environment.

In some implementations, the system may allow for adjustment of a fitness function threshold, which may be used to determine whether a generated rule is sufficiently effective to be included in a final ruleset. The fitness function threshold may be expressed as a single value that represents a minimum acceptable score for rule acceptance. When expressed as a single value, the fitness function may combine multiple performance metrics into a unified score, and rules achieving a score at or above the threshold may be accepted while rules falling below the threshold may be rejected or subjected to further refinement. Alternatively, the fitness function threshold may be expressed as a combination of multiple performance metrics, where each metric has its own threshold requirement. When expressed as a combination of multiple metrics, a rule may be required to meet or exceed threshold values for each individual metric to be accepted. For example, the fitness function threshold may require that a rule achieve a minimum precision value and a minimum number of true positives simultaneously. This multi-metric threshold approach may enable more granular control over the characteristics of accepted rules by ensuring that rules meet minimum standards across multiple dimensions of performance rather than allowing deficiency in one metric to be offset by strength in another.

In some implementations, the system may include parameters for controlling the complexity of generated rules. These complexity control parameters may include a maximum rule length parameter that specifies the maximum number of conditions or clauses that a generated rule may contain. Rules that exceed the maximum rule length may be rejected or may be simplified through removal of conditions until the rule conforms to the length constraint. The complexity control parameters may also include a parameter specifying the number of allowed logical operators that may appear within a generated rule. Logical operators may include conjunctive operators that require multiple conditions to be satisfied simultaneously, disjunctive operators that require any of multiple conditions to be satisfied, and negation operators that invert the truth value of conditions. Limiting the number of allowed logical operators may constrain the structural complexity of generated rules.

The system may also include parameters for controlling the balance between precision and recall in the generated rules. Precision measures the proportion of events flagged as malicious by a rule that are actually malicious, while recall measures the proportion of actual malicious events that are correctly identified by the rule. These two metrics may exhibit a trade-off relationship, where increasing precision may reduce recall and increasing recall may reduce precision. The balance control parameters may include weights that are applied to precision and recall when computing the fitness function score, where higher weight on precision may favor rules that minimize false positives while higher weight on recall may favor rules that maximize detection of malicious events. The balance control parameters may be adjusted based on the specific requirements of the cybersecurity application. In environments where false positives impose high costs due to alert fatigue or resource consumption for investigation, the parameters may be configured to prioritize precision. In environments where detection of malicious events is paramount and false positives are more tolerable, the parameters may be configured to prioritize recall.

In some implementations, the system may allow for configuration of ensemble methods that determine how multiple generated rules are combined or weighted to produce final detection decisions. Ensemble methods may aggregate the outputs of multiple rules to produce a collective detection decision that may exhibit different characteristics than the decisions of individual rules. The ensemble configuration may specify how rules are combined, which may include voting mechanisms where an event is classified as malicious if a threshold number or proportion of rules flag the event as malicious. The ensemble configuration may also specify weights assigned to individual rules, where rules with higher weights contribute more strongly to the collective detection decision. Weights may be assigned based on the performance characteristics of individual rules, with higher-performing rules receiving higher weights. The ensemble configuration may further specify aggregation functions that combine rule outputs, which may include averaging of rule scores, maximum or minimum selection among rule outputs, or more complex aggregation functions that account for correlations between rules.

In some implementations, the rule selection process may incorporate diversity criteria that guarantees the final ruleset covers a wide range of potential threat patterns. When selecting rules for inclusion in the final ruleset, the system may consider not only the individual performance of each rule but also the collective coverage provided by the selected rules. Diversity criteria may favor selection of rules that detect different types of malicious events or that rely on different attributes and conditions for detection. By incorporating diversity criteria, the rule selection process may avoid selecting multiple rules that are highly similar and that detect the same subset of malicious events while missing other threat patterns. The diversity criteria may be implemented through analysis of the true positive samples detected by each candidate rule, where rules that detect samples not covered by previously selected rules may be favored over rules that detect samples already covered. The diversity criteria may also be implemented through analysis of the structural characteristics of rules, where rules that employ different conditions or logical structures may be favored to promote variety in detection approaches.

In some implementations, the autonomous rule generation system may include a user interface that allows cybersecurity professionals to interact with the rule generation process. The user interface may provide functionality for setting parameters (such as those noted above) that control the behavior of the rule generation system. Through the user interface, cybersecurity professionals may configure parameters such as, for example, the fitness function threshold, the patience parameter that controls the number of refinement iterations, the maximum number of overall iterations, and the sampling parameters that influence rule diversity.

In some implementations, the user interface may provide functionality for reviewing generated rules. Cybersecurity professionals may examine the rules that the system has generated, including the conditions and logic that each rule employs for detecting malicious events. The user interface may display rules in a human-readable format that presents the rule structure, the attributes referenced by the rule, and the logical relationships between conditions. The user interface may also display performance metrics associated with each rule, including precision, recall, true positive count, and false positive count. By presenting both the rule logic and the associated performance metrics, the user interface may enable cybersecurity professionals to assess whether generated rules align with organizational detection requirements and to identify rules that may require modification or further review.

In some implementations, the user interface may provide functionality for manually adjusting generated rules. Cybersecurity professionals may modify the conditions, attribute values, or logical structure of rules through the user interface. Manual adjustments may include adding conditions to increase rule specificity, removing conditions to broaden rule coverage, modifying attribute values to adjust the scope of matched events, or changing logical operators to alter the relationships between conditions. The user interface may validate manual adjustments to ensure that modified rules conform to syntactic requirements and may re-evaluate modified rules against the dataset to provide updated performance metrics. This manual adjustment functionality may enable cybersecurity professionals to incorporate domain expertise and operational knowledge into the rule generation process, refining rules based on insights that may not be captured in the labeled dataset.

The user interface may also provide functionality for approving rules before deployment in production environments. Cybersecurity professionals may review candidate rules and indicate approval for rules that meet organizational standards for detection quality and operational suitability. Rules that receive approval may be marked for deployment, while rules that do not receive approval may be returned for further refinement or may be excluded from the final ruleset.

As new cybersecurity data becomes available, the system may incorporate this data into the rule generation and evaluation processes. New data may include samples of recently observed malicious events, samples representing emerging attack techniques, or samples that reflect changes in the characteristics of benign activity within the monitored environment. In some implementations, the system may adapt rule generation strategies as new types of threats emerge. When new categories of malicious behavior are identified and added to the labeled dataset, the system may generate rules specifically targeting these new threat categories. The iterative refinement process may enable the system to develop effective detection rules for emerging threats by progressively improving candidate rules based on feedback from evaluation against samples of the new threat types. The system may also modify existing rules or generate supplementary rules when evaluation indicates that current rules are not effectively detecting newly emerged threat patterns. These continuous learning mechanisms may enable the system to maintain effectiveness over time as the threat landscape evolves. Cybersecurity threats may change in response to defensive measures, technological developments, and shifts in attacker objectives and capabilities. The continuous learning mechanisms may enable the system to respond to these changes by updating the data used for rule generation and evaluation, by generating new rules that address emerging patterns, and by identifying existing rules that may require modification or replacement.

### XDR Implementations

In some implementations, the autonomous rule generation system may be applied to Extended Detection and Response (XDR) data to generate deterministic rules for detecting malicious events across multiple security layers within an organization's infrastructure. XDR systems collect and correlate data from multiple security domains, providing a comprehensive view of security-relevant activities across an organization's digital environment. The autonomous rule generation system may leverage this comprehensive data to generate rules that address threat patterns spanning multiple components of the security infrastructure.

In some implementations, the autonomous rule generation system may process various types of XDR data as input for rule generation and evaluation. The system may process network traffic logs, which may include records of network communications such as source and destination addresses, port numbers, protocol identifiers, packet sizes, connection durations, and timing information. Network traffic logs may capture patterns of communication between systems within an organization's network and between internal systems and external endpoints. The system may analyze network traffic logs to identify patterns indicative of malicious network activity such as command-and-control communications, lateral movement between systems, or data exfiltration attempts.

In some implementations, the system may process endpoint activity logs, which may include records of activities occurring on individual computing devices such as workstations, servers, and mobile devices. Endpoint activity logs may capture information about process executions, including process names, command line arguments, parent-child process relationships, and execution timestamps. Endpoint activity logs may also capture information about file system operations such as file creation, modification, deletion, and access events. Additionally, endpoint activity logs may include records of registry modifications on systems that maintain registry databases, user authentication events, and changes to system configurations. The system may analyze endpoint activity logs to identify patterns indicative of malicious endpoint activity such as suspicious process behaviors, unauthorized file modifications, or persistence mechanisms employed by malware.

In some implementations, the system may process user behavior data, which may include records of user activities across systems and applications within an organization's environment. User behavior data may capture information about user authentication events, including login times, authentication methods, and access locations. User behavior data may also capture information about user access patterns, including resources accessed, access frequencies, and access timing. The system may analyze user behavior data to identify patterns indicative of compromised user accounts, insider threats, or unauthorized access attempts.

In some implementations, the system may process application logs, which may include records generated by software applications documenting application-specific activities, errors, state changes, and user interactions. Application logs may capture information about application operations, error conditions, configuration changes, and security-relevant events within the application context. The system may analyze application logs to identify patterns indicative of application-level attacks, exploitation of application vulnerabilities, or misuse of application functionality.

In some implementations, the system may process cloud infrastructure logs, which may include records of activities within cloud computing environments such as infrastructure-as-a-service, platform-as-a-service, and software-as-a-service deployments. Cloud infrastructure logs may capture information about resource provisioning and deprovisioning, configuration changes, access control modifications, and API calls to cloud services. The system may analyze cloud infrastructure logs to identify patterns indicative of cloud-specific threats such as unauthorized resource access, misconfiguration exploitation, or abuse of cloud service capabilities.

In some implementations, the autonomous rule generation system may generate rules specifically tailored to different components of the XDR ecosystem. For example, the system may generate endpoint-focused rules that target detection of malicious activities occurring on individual computing devices. Endpoint-focused rules may specify conditions based on process execution characteristics, file system operations, registry modifications, or other endpoint-specific attributes. These endpoint-focused rules may be deployed to endpoint detection agents or endpoint protection platforms to enable detection of malicious activity at the device level.

The system may generate network-focused rules that target detection of malicious network communications and traffic patterns. Network-focused rules may specify conditions based on network connection attributes, traffic volume characteristics, protocol behaviors, or communication patterns between systems. These network-focused rules may be deployed to network detection systems, firewalls, or network monitoring platforms to enable detection of malicious network activity at the network infrastructure level.

In some implementations, the system may generate rules that target detection of malicious activities specifically within cloud computing environments. Cloud-focused rules may specify conditions based on cloud API calls, resource configuration states, access patterns to cloud services, or cloud-specific event attributes. These cloud-focused rules may be deployed to cloud security monitoring tools or cloud-native security services to enable detection of malicious activity within cloud infrastructure.

### Alternative Implementations

In some implementations, the autonomous rule generation system may be integrated with Security Information and Event Management (SIEM) platforms. SIEM platforms aggregate security event data from multiple sources across an organization's infrastructure and provide capabilities for event correlation, analysis, and alerting. Integration with SIEM platforms may enable the autonomous rule generation system to receive input data from the aggregated event streams collected by the SIEM platform. The generated rules may be deployed within the SIEM platform to enable detection of malicious patterns across the correlated event data. This integration may enable organizations to leverage the data aggregation and correlation capabilities of SIEM platforms in combination with the automated rule generation capabilities of the autonomous rule generation system.

In some implementations, the autonomous rule generation system may be integrated with Security Orchestration, Automation, and Response (SOAR) tools. SOAR tools provide capabilities for automating security operations workflows, orchestrating responses across multiple security tools, and managing incident response processes. Integration with SOAR tools may enable automated responses to threats detected by rules generated by the autonomous rule generation system. When a generated rule detects a malicious event, the SOAR tool may automatically initiate response actions such as isolating affected systems, blocking malicious network communications, disabling compromised user accounts, or triggering incident response workflows. This integration may enable organizations to reduce the time between threat detection and response by automating response actions based on detections from generated rules.

In some implementations, the autonomous rule generation system may be adapted for applications beyond cybersecurity threat detection. The underlying framework for generating deterministic rules through iterative refinement using a language model, validator, and feedback module may be applied to other domains where classification of discrete sequential data is valuable. For example, the system may be adapted for use in financial fraud detection to identify unusual transaction patterns or potentially fraudulent activities. Financial institutions process large volumes of transaction data that may include attributes such as transaction amounts, merchant categories, geographic locations, transaction timing, and account characteristics. The autonomous rule generation system may receive labeled datasets containing examples of fraudulent transactions and legitimate transactions. The language model may analyze samples of fraudulent transactions and generate candidate rules that capture patterns indicative of fraudulent activity. The validator may assess candidate rules against the labeled transaction dataset to measure precision and detection coverage. The feedback module may provide information about false positives and false negatives to guide iterative refinement of the rules. The generated rules may express conditions based on transaction attributes that distinguish fraudulent transactions from legitimate transactions, such as unusual transaction amounts, atypical merchant categories for a given account, geographic anomalies, or timing patterns that deviate from established account behavior. The deterministic nature of the generated rules may provide explainability that is valuable in financial contexts where regulatory requirements may mandate documentation of fraud detection logic and where investigators may need to understand the basis for flagging specific transactions.

In some implementations, the system may find applications in healthcare for detecting anomalies in patient data or identifying potential drug interactions. Healthcare systems generate substantial volumes of patient data including medical records, laboratory results, medication prescriptions, vital sign measurements, and diagnostic codes. The autonomous rule generation system may be adapted to process healthcare data and generate rules for identifying anomalous patterns that may indicate medical conditions requiring attention, adverse events, or potential safety concerns. The language model may analyze samples of patient data associated with specific conditions or adverse events and generate candidate rules that capture patterns indicative of these situations. The validator may assess candidate rules against labeled healthcare datasets to measure detection performance. The generated rules may express conditions based on combinations of laboratory values, vital sign measurements, medication combinations, or diagnostic codes that are associated with specific clinical concerns. For drug interaction detection, the system may generate rules that identify combinations of prescribed medications that may produce adverse interactions, based on analysis of patient records where such interactions have been documented. The explainability of the generated rules may be valuable in healthcare contexts where clinicians may need to understand the rationale behind alerts and where documentation of detection logic may support clinical decision-making and quality assurance processes.

In some implementations, the system may be applied to industrial control systems for anomaly detection in manufacturing processes. Industrial control systems generate data from sensors monitoring equipment operation, production parameters, environmental conditions, and quality measurements. The autonomous rule generation system may be adapted to process industrial sensor data and generate rules for identifying anomalies that may indicate equipment malfunctions, quality control issues, or process inefficiencies. The language model may analyze samples of sensor data associated with known equipment failures, quality defects, or process deviations and generate candidate rules that capture patterns indicative of these conditions. The validator may assess candidate rules against labeled industrial datasets to measure detection accuracy. The generated rules may express conditions based on sensor readings, production metrics, or combinations of measurements that are associated with specific operational concerns. The rules may identify patterns such as unusual temperature readings, vibration signatures indicative of mechanical wear, pressure variations suggesting equipment degradation, or production rate deviations indicating process inefficiencies. The deterministic rules generated by the system may be deployed to monitoring systems within industrial environments to enable detection of anomalies that may warrant maintenance intervention or process adjustment.

In some implementations, the system may be extended to support multi-modal data analysis incorporating data from various sources such as text, images, and sensor readings. Multi-modal data analysis involves processing and correlating information from different data types to identify patterns that may not be apparent when analyzing individual data modalities in isolation. The autonomous rule generation system may be extended to receive input data comprising multiple modalities and to generate rules that incorporate conditions spanning different data types. For example, in a security context, the system may generate rules that combine conditions based on textual log data, visual data from surveillance systems, and sensor data from access control systems. In a healthcare context, the system may generate rules that combine conditions based on clinical notes, medical imaging findings, and physiological sensor measurements. The language model may be configured to process representations of multi-modal data and to generate candidate rules that express conditions across different data types. The validator may assess candidate rules against multi-modal datasets where samples include data from multiple sources. The generated rules may capture complex patterns that involve relationships between different data modalities, potentially enabling detection of conditions that would not be identifiable through analysis of any single data type alone.

### Computer System

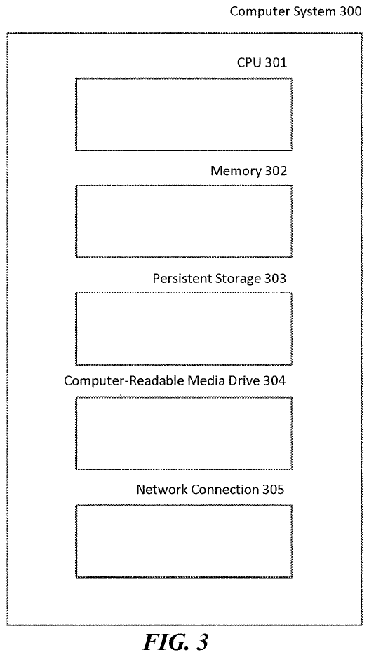

FIG. 3 is a block diagram showing some of the components typically incorporated in at least some of the computer systems and other devices on which the disclosed system operates. In various implementations, these computer systems, and other devices 300 can include server computer systems, desktop computer systems, laptop computer systems, netbooks, mobile phones, personal digital assistants, televisions, cameras, automobile computers, electronic media players, etc. In various implementations, the computer systems and devices include zero or more of each of the following: a central processing unit (CPU) 301 for executing computer programs; a computer memory 302 for storing programs and data while they are being used, including the facility and associated data, an operating system including a kernel, and device drivers; a persistent storage device 303, such as a hard drive or flash drive for persistently storing programs and data; computer-readable media drives 304 that are tangible storage means that do not include a transitory, propagating signal, such as a floppy, CD-ROM, or DVD drive, for reading programs and data stored on a computer-readable medium; and a network connection 305 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations and having various components.

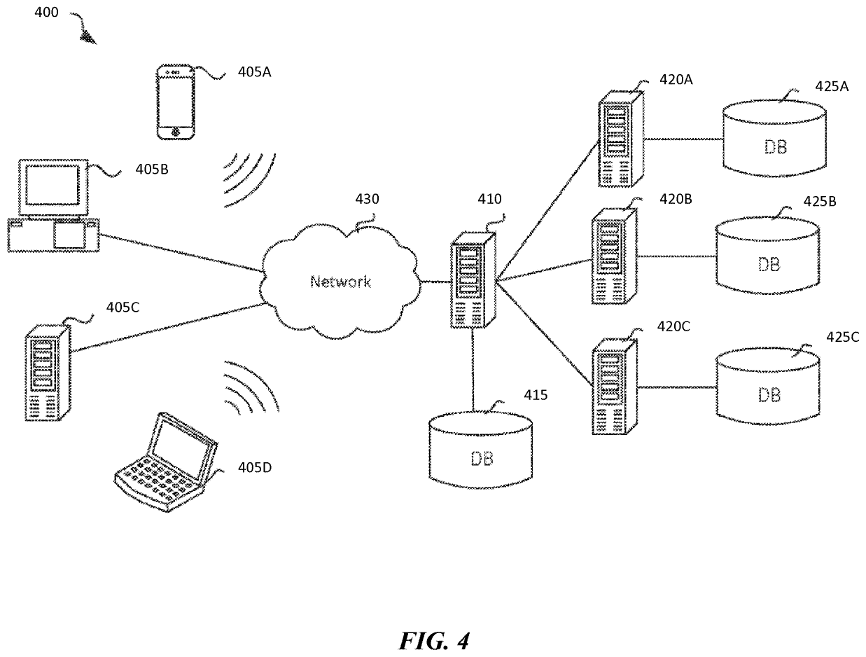

FIG. 4 is a system diagram illustrating an example of a computing environment in which the disclosed system operates in some implementations. In some implementations, environment 400 includes one or more client computing devices 405A-D, examples of which can host the system. Client computing devices 405 operate in a networked environment using logical connections through network 430 to one or more remote computers, such as a server computing device.

In some implementations, server 410 is an edge server which receives client requests and coordinates fulfillment of those requests through other servers, such as servers 420A-C. In some implementations, server computing devices 410 and 420 comprise computing systems, such as the system. Though each server computing device 410 and 420 is displayed logically as a single server, server computing devices can each be a distributed computing environment encompassing multiple computing devices located at the same or at geographically disparate physical locations. In some implementations, each server 420 corresponds to a group of servers.

Client computing devices 405 and server computing devices 410 and 420 can each act as a server or client to other server or client devices. In some implementations, servers (410, 420A-C) connect to a corresponding database (415, 425A-C). As discussed above, each server 420 can correspond to a group of servers, and each of these servers can share a database or can have its own database. Databases 415 and 425 warehouse (e.g., store) information such as home information, recent sales, home attributes, and so on. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN) but can also be other wired or wireless networks. In some implementations, network 430 is the Internet or some other public or private network. Client computing devices 405 are connected to network 430 through a network interface, such as by wired or wireless communication. While the connections between server 410 and servers 420 are shown as separate connections, these connections can be any kind of local, wide area, wired, or wireless network, including network 430 or a separate public or private network.

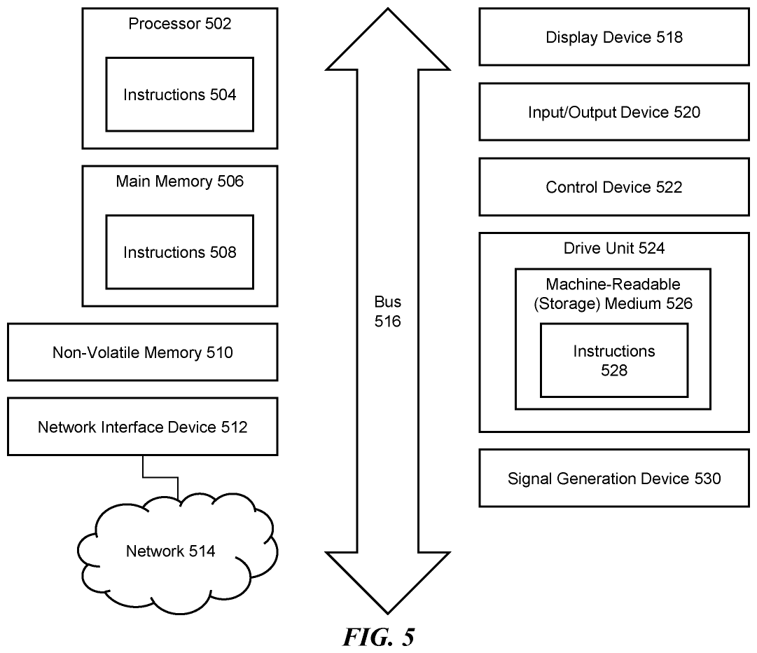

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for generating deterministic rules for classification tasks on discrete sequential data, comprising:
a processor;
a memory coupled to the processor; and
instructions stored on the memory that, when executed by the processor, cause the system to perform a method comprising:
receiving input data comprising labeled data, the labeled data comprising a plurality of malicious samples and a plurality of non-malicious samples;
generating, by a language model, a candidate rule based at least on the input data, wherein generating the candidate rule comprises selecting tokens from a smallest set of tokens whose cumulative probability exceeds a cumulative probability threshold, and wherein the candidate rule comprises a deterministic function configured to classify events as malicious or non-malicious;
evaluating the candidate rule against an evaluation dataset, wherein the evaluating comprises:
applying the candidate rule to samples in the evaluation dataset to identify a number of true positive detections and false positive detections;
computing performance metrics for the candidate rule based at least on a precision value and a number of true positive detections by the candidate rule identified when the candidate rule is applied to the samples; and
determining whether the performance metrics meet a threshold level;
generating and providing feedback to the language model for the candidate rule when the performance metrics do not meet the threshold level, wherein the feedback comprises at least one true positive sample and at least one false positive sample identified when the candidate rule is applied to the samples;
iteratively refining the candidate rule until the performance metrics meet the threshold level to generate a deterministic rule; and
storing the deterministic rule in a rule dataset.

2. The system of claim 1, wherein the method further comprises sampling a plurality of candidate rules from the language model for each iteration of the iteratively refining.

3. The system of claim 2, wherein the method further comprises sampling tokens for the plurality of candidate rules from a smallest set of probable tokens whose cumulative probability exceeds the cumulative probability threshold.

4. The system of claim 2, wherein the evaluating further comprises using a fitness function to select between the plurality of candidate rules based on the performance metrics of each candidate rule.

5. The system of claim 4, wherein the fitness function incorporates a weighted combination of the precision value and the number of true positive detections to produce a fitness score for each candidate rule.

6. The system of claim 1, wherein the method further comprises randomly sampling true positive samples and false positive samples from the evaluation dataset to provide as the feedback to the language model.

7. The system of claim 1, wherein the method further comprises removing true positive samples covered by the deterministic rule from the evaluation dataset.

8. The system of claim 7, wherein the method further comprises repeating the method on remaining samples in the evaluation dataset after removing the true positive samples covered by the deterministic rule.

9. The system of claim 1, wherein the method further comprises terminating the iteratively refining of the candidate rule after a predefined number of iterations.

10. The system of claim 9, wherein the method further comprises sampling a new true positive sample from the plurality of malicious samples and restarting the generation of the candidate rule when the predefined number of iterations is reached without producing the deterministic rule.

11. The system of claim 1, wherein the language model is trained on cybersecurity-specific data.

12. A method for generating deterministic rules for classification tasks on discrete sequential data, comprising:
receiving input data comprising labeled data, the labeled data comprising a plurality of malicious samples and a plurality of non-malicious samples;
generating, by a language model, a candidate rule based at least on the input data, wherein generating the candidate rule comprises selecting tokens from a smallest set of tokens whose cumulative probability exceeds a cumulative probability threshold, and wherein the candidate rule comprises a deterministic function configured to classify events as malicious or non-malicious;
evaluating the candidate rule against an evaluation dataset, wherein the evaluating comprises:
applying the candidate rule to samples in the evaluation dataset to identify a number of true positive detections and false positive detections;
computing performance metrics for the candidate rule based at least on a precision value and a number of true positive detections by the candidate rule identified when the candidate rule is applied to the samples; and
determining whether the performance metrics meet a threshold level;
generating and providing feedback to the language model for the candidate rule when the performance metrics do not meet the threshold level, wherein the feedback comprises at least one true positive sample and at least one false positive sample identified when the candidate rule is applied to the samples;
iteratively refining the candidate rule until the performance metrics meet the threshold level to generate a deterministic rule; and
storing the deterministic rule in a rule dataset.

13. The method of claim 12, further comprising sampling a plurality of candidate rules from the language model for each iteration of the iteratively refining.

14. The method of claim 13, further comprising sampling tokens for the plurality of candidate rules from a smallest set of probable tokens whose cumulative probability exceeds the cumulative probability threshold.

15. The method of claim 13, further comprising using a fitness function to select between the plurality of candidate rules, wherein the fitness function incorporates a weighted combination of the precision value and the number of true positives to produce a fitness score for each candidate rule.

16. The method of claim 12, further comprising removing true positive samples covered by the deterministic rule from the evaluation dataset.

17. The method of claim 12, further comprising terminating the iteratively refining of the candidate rule after a predefined number of iterations.

18. A non-transitory computer-readable medium storing instructions that, when executed by one or more processors, cause the one or more processors to perform operations comprising:
receiving input data comprising labeled data, the labeled data comprising a plurality of malicious samples and a plurality of non-malicious samples;
generating, by a language model, a candidate rule based at least on the input data, wherein generating the candidate rule comprises selecting tokens from a smallest set of tokens whose cumulative probability exceeds a cumulative probability threshold, and wherein the candidate rule comprises a deterministic function configured to classify events as malicious or non-malicious;
evaluating the candidate rule against an evaluation dataset, wherein the evaluating comprises:
applying the candidate rule to samples in the evaluation dataset to identify a number of true positive detections and false positive detections;
computing performance metrics for the candidate rule based at least on a precision value and a number of true positive detections by the candidate rule identified when the candidate rule is applied to the samples; and
determining whether the performance metrics meet a threshold level;
generating and providing feedback to the language model for the candidate rule when the performance metrics do not meet the threshold level, wherein the feedback comprises at least one true positive sample and at least one false positive sample identified when the candidate rule is applied to the samples;
iteratively refining the candidate rule until the performance metrics meet the threshold level to generate a deterministic rule; and
storing the deterministic rule in a rule dataset.

19. The non-transitory computer-readable medium of claim 18, wherein the operations further comprise sampling a plurality of candidate rules from the language model for each iteration of the iteratively refining.

20. The non-transitory computer-readable medium of claim 19, wherein the operations further comprises sampling tokens for the plurality of candidate rules from a smallest set of probable tokens whose cumulative probability exceeds the cumulative probability threshold.
